(19) United States
(12) Patent Application Publication
(10) Pub. No.: US 2006/0051563 A1
(43) Pub. Date: Mar. 9, 2006

(54) Organic electroluminescence device

(76) Inventors: Kenji Okumoto, Hirakata-city (JP); Hiroshi Kanno, Osaka-city (JP)

Correspondence Address: MCDERMOTT WILL & EMERY LLP, 600 13TH STREET, N.W., WASHINGTON, DC, 20005-3096, US

(21) Appl. No.: 11/084,187

(22) Filed: Mar. 21, 2005

(30) Foreign Application Priority Data
Mar. 25, 2004 (JP) 2004-89208
Mar. 25, 2004 (JP) 2004-89210
Dec. 24, 2004 (JP) 2004-374056

(51) Int. Cl. H05B 33/12

(52) U.S. Cl. 428/212; 428/690; 428/917; 313/504; 313/506

(57) ABSTRACT

An organic electroluminescent device in which a light emitting layer is disposed between a hole injection electrode and an electron injection electrode, and a hole transporting layer is disposed between a hole injection electrode and a light emitting layer, wherein the hole transporting layer contains an electron trapping material exhibiting a reversible cathode reduction process in cyclic voltammetry measurement and having a reduction potential smaller than that of a hole transporting material contained in the hole transporting layer, or wherein the electron transporting layer contains a hole trapping material exhibiting a reversible anode reduction process in cyclic voltammetry measurement and having an oxidation potential smaller than that of an electron transporting material contained in the electron transporting layer.

The priority Japanese Patent Application Numbers 2004-89208, 2004-89210 and 2004-374056 upon which this patent application is based is hereby incorporated by reference.

### BACKGROUND OF THE INVENTION

1. Field of the Invention

The present invention relates to an organic electroluminescence device, more particularly, an organic electroluminescence device excellent in light emitting life property.

2. Description of the Related Art

An organic electroluminescence device (organic EL device) is being actively developed from a viewpoint of application to display and illumination. A principle of driving an organic EL device is as follows. That is, a hole and an electron are injected from a hole injection electrode and an electron injection electrode, respectively, they are transported into an organic thin film, and recombined in a light emitting layer, thereby, the excited state is generated, and light emission is obtained from this excited state.

In practical implementation of an organic EL device, a greatest problem is light emitting life property. Among deterioration mechanisms of an organic EL device, electrochemical deterioration of an organic substance is one of most important matters. Herein, electrochemical deterioration of an organic substance means that a radical cation generated when an organic substance accepts a hole, or a radical anion generated when an organic substance accepts an electron is unstable, and thereby an organic substance is chemically changed.

Generally, a hole transporting substance is unstable in the state where the substance accepts an electron (radical anion state). For example, it is known that NPB (N,N′-di(1-naphthyl)-N,N′-diphenylbenzidine) which is a currently widely used hole transporting material is unstable in the radical anion state.

In addition, an electron transporting substance is unstable in the state where the substance accepts a hole (radical cation state). For example, it is known that Alq (tris-(8-quinolinato)aluminum (III)) which is a currently widely used electron transporting material is unstable in the radical cation state.

Therefore, in order to improve life property of an organic EL device, it is effective to prevent electrochemical deterioration of an organic substance. In Science, No. 283, page 1990 in 1999, it is reported that life property of an organic EL device can be improved by adopting a mixture of a hole transporting material and an electron transporting material as a light emitting layer. Like this, a procedure of improving durability of a device by constructing a light emitting layer of a few kinds of organic substances has been shown in academic papers and patents in many cases. However, in order to further progress practical implementation of an organic EL device, it is necessary to further improve light emitting life property.

### SUMMARY OF THE INVENTION

An object of the present invention is to provide an organic EL device excellent in light emitting life property.

A first aspect of the present invention is an organic EL device in which a light emitting layer is disposed between a hole injection electrode and an electron injection electrode, and a hole transporting layer is disposed between a hole injection electrode and a light emitting layer, characterized in that, the hole transporting layer contains an electron trapping material exhibiting a reversible cathode reduction process in cyclic voltammetry measurement and having a reduction potential smaller than that of a hole transporting material contained in the hole transporting layer.

In the first aspect of the present invention, an electron trapping material satisfying two conditions is contained in a hole transporting layer as described above.

The first condition is that a reversible cathode reduction process is exhibited in cyclic voltammetry measurement. This can be determined from a curve of a cyclic voltammogram measured in cyclic voltammetry. For example, when a cathode reduction process is repeated about three times, and curves of a cyclic voltammogram of respective times are expressed approximately overlapped, it can be determined that reversibility is possessed, and a reversible cathode reduction process is exhibited. To the contrary, when curves of a cyclic voltammogram of respective times are not overlapped and are greatly slipped, it is determined that reversibility is not possessed, and an irreversible cathode reduction process is exhibited.

In addition, reversibility in cyclic voltammetry can be also determined from the following Nicolson's equation described in A. Bard, L. R. Faulkner, Electrochemical Methods Fundamentals and Application, John Wiley & Sons; New York, 2001; p 240.
I_{pc}/Iₚₐ=Ipco/Ipao+0.485×Ipso/Ipao+0.086

Ipco, Ipao and Ipso in the aforementioned Nicolson's equation will be explained by referring to FIG. 3. FIG. 3 is a view showing a rubrene cyclic voltammogram. First, when the absolute value of the potential is increased, reduction progresses, and the current increases along with the arrow A. A current value when a curve is at a lowest end is Ipao, and a potential at this stage is E¹. The absolute value of the potential is further increased along with the arrow B, and is positioned at a left end of the curve. A current value at this stage is Ipso. Then, the absolute value of the potential is decreased along with the arrow C, and the curve is elevated and is positioned at an uppermost end. A current value at this stage is Ipco, and apotential at this stage t is E². A reduction potential (E^{red}) of a material is determined by the following equation.
E^{red}=(E¹+E²)/2

By substituting values of Ipco, Ipao and Ipso obtained from a cyclic voltammogram as described above into the Nicolson's equation, I_{pc}/Iₚₐ can be calculated. It can be determined that, as a value of this I_{pc}/Iₚₐ approaches 1, reversibility is higher. In the present invention, the value is preferably in a range of 1.2 to 0.8, further preferably in a range of 1.1 to 0.9.

The second condition is that, in cyclic voltammetry measurement, a reduction potential is smaller than a reduction potential of a hole transporting material in a hole transporting layer. Herein, a smaller reduction potential means that an absolute value of a reduction potential is smaller. For example, it is determined that a reduction potential of −1 V has a smaller reduction potential than a reduction potential of −2 V.

Since a reduction potential and an energy level in a lowest unoccupied molecular orbital (LUMO) have a correlation, a small reduction potential has a low energy level in a lowest unoccupied molecular orbital (LUMO).

In the first aspect of the present invention, since an electron trapping material to be contained in a hole transporting layer has a smaller reduction potential than that of a hole transporting material, its energy in a lowest unoccupied molecular orbital (LUMO) is also smaller than that of a hole transporting material. For this reason, an electron which has escaped from a light emitting layer and transferred into a hole transporting layer can be stably trapped, and breakage of a hole transporting material due to this electron can be prevented. Since an electron trapping material shows a reversible cathode reduction process, an electron trapping material itself is not deteriorated by an electron.

Previously, enhancement of light emitting life property has been tried by inclusion of an electron transporting material in a light emitting layer, and this pays an attention to a point that balance of charges is improved so that an electron is not escaped from a light emitting layer. In the first aspect of the present invention, an attention is paid to the fact that it is difficult to completely prevent an electron from escaping from a light emitting layer, and light emitting life property is improved by stably trapping an electron escaped from a light emitting layer in a hole transporting layer.

A concentration of an electron trapping material in a hole transporting layer in the first aspect of the present invention is preferably in a range of 0.1 to 30% by weight, further preferably in a range of 0.5 to 10% by weight, further preferably in a range of 1 to 5% by weight.

When a concentration of an electron trapping material is too high, since a hole transporting layer transports an electron, an amount of an electron escaped from a light emitting layer becomes large, and there is a possibility that a light emitting efficiency is reduced. On the other hand, when a concentration of an electron trapping material is too low, the effect of the present invention of improving light emitting life property is not sufficiently obtained in some cases.

The electron trapping material may be contained through a hole transporting layer, or may be contained in a region of a part of a hole transporting layer.

The electron trapping material is not particularly limited as far as it satisfies the aforementioned first condition and second condition, but examples include compounds satisfying the aforementioned first condition and second condition among compounds such as a perylene derivative, an anthraquinone derivative, an anthracene derivative and a rubrene derivative.

A hole transporting material in a hole transporting layer in the first aspect of the present invention is not particularly limited as far as it is a material having hole transporting property, but materials which are used as a hole transporting material in an organic EL device can be used. Examples of such the hole transporting material include an aryl amine derivative.

It is preferable that a light emitting layer in the first aspect of the present invention is formed of a host material and a dopant material. Examples of the host material of a light emitting layer include an anthracene derivative, an aluminum complex, a rubrene derivative, and an arylamine derivative.

In addition, as the dopant material, a singlet light emitting material may be used, or a triplet light emitting material may be used. In order to obtain a high light emitting efficiency, it is preferable to use a triplet light emitting material which is a phosphorescent emitting material. Examples of the singlet light emitting material include a perylene derivative, a coumarin derivative, an anthracene derivative, a tetracene derivative, and a styrylbenzene derivative. In addition, examples of the triplet light emitting material (phosphorescent emitting material) include an iridium complex and a platinum complex.

A light emitting layer in the first aspect of the present invention may be constituted of only one layer, or may be constituted of two layers or three layers having different emitting colors. When a light emitting layer is constituted of a plurality of layers, for examples, by combining a blue emitting layer and an orange emitting layer, an organic EL device of the first aspect of the present invention can be made to be a white emitting device.

According to the first aspect of the present invention, since an electron which has invaded into a hole transporting layer can be stably trapped by an electron trapping material, deterioration of a hole transporting material due to an electron can be prevented. For this reason, an organic EL device excellent in light emitting life property can be obtained. In addition, accompanying therewith, improvement in properties of an organic EL device such as improvement in a light emitting efficiency and reduction in a driving voltage can be expected.

A second aspect of the present invention is an organic EL device in which a light emitting layer is disposed between a hole injection electrode and an electron injection electrode, and an electron transporting layer is disposed between the electron injection electrode and the light emitting layer, characterized in that, the electron transporting layer contains a hole trapping material exhibiting a reversible anode reduction process in cyclic voltammetry measurement and having an oxidation potential smaller than that of an electron transporting material contained in the electron transporting layer.

In the second aspect of the present invention, a hole trapping material satisfying two conditions is contained in an electron transporting layer as described above.

The first condition is that, in cyclic voltammetry measurement, a reversible anode oxidation process is exhibited. This can be determined from a curve of a cyclic voltammogram measured in cyclic voltammetry. For example, when an anode oxidation process is repeated about three times, and curves of a cyclic voltammogram of respective times are expressed approximately overlapped, it can be determined that reversibility is possessed, and a reversible anode oxidation process is exhibited. To the contrary, when curves of a cyclic voltammogram of respective times are not overlapped, and are greatly slipped, it is determined that reversibility is not possessed, and an irreversible anode oxidation process is exhibited.

In addition, reversibility in cyclic voltammetry can be also determined by the following Nicolson's equation described in A. Bard, L. R. Faulkner, Electrochemical Methods Fundamentals and Application, John Wiley & Sons; New York, 2001; p 240.
I_{pc}/Iₚₐ=Ipco/Ipao+0.485×Ipso/Ipao+0.086

Ipco, Ipao and Ipso in the aforementioned Nicolson's equation will be explained by referring to FIG. 15. FIG. 15 is a view showing a cyclic voltammogram of m-MTDATA. First, when the absolute value of the potential is increased, oxidation progresses, and the current increases along with the arrow A. A current value when a curve is positioned at an uppermost end is Ipao, and a potential at this stage is E¹. The absolute value of the potential is further increased along with the arrow B, and is positioned at a right end of a curve. A current value at this stage is Ipso. Then, the absolute value of the potential is decreased along with the arrow C, and the curve is fallen, and is positioned at a lowest end. A current value at this stage is Ipco, and a potential at this stage is E². An oxidation potential (E^{ox}) of a material is determined by the following equation.
E^{ox}=(E¹+E²)/2

By substituting values of Ipco, Ipao and Ipso obtained from a cyclic voltammogram as described above into the Nicolson's equation, I_{pc}/Iₚₐ can be calculated. It can be determined that, as a value of this I_{pc}/Iₚₐ approaches 1, reversibility is high. In the present invention, the value is preferably in a range of 1.2 to 0.8, further preferably in a value of 1.1 to 0.9.

The second condition is that, in cyclic voltammetry measurement, an oxidation potential is smaller than an oxidation potential of an electron transporting material in an electron transporting layer. Herein, a smaller oxidation potential means that an absolute value of an oxidation potential is smaller.

Since an oxidation potential and an energy level in a highest occupied molecular orbital (HOMO) have a correlation, a smaller oxidation potential has a higher energy level in a highest occupied molecular orbital (HOMO).

In the second aspect of the present invention, since a hole trapping material to be contained in an electron transporting layer has a smaller oxidation potential than that of an electron transporting material, its energy in a highest occupied molecular orbital (HOMO) is higher than that of an electron transporting material. For this reason, a hole which has escaped from a light emitting layer and transferred into an electrode transporting layer can be stably trapped, and breakage of an electron transporting material due to this hole can be prevented. In addition, since a hole trapping material shows a reversible anode oxidation process, a hole trapping material itself is not deteriorated due to a hole.

Previously, improvement in balance of charges, and provision of a hole arresting layer have been tried so that a hole is not escaped from a light emitting layer. In the second aspect of the present invention, an attention is paid to the fact that it is difficult to completely prevent a hole escaping from a light emitting layer, and light emitting life property is improved by stably trapping a hole which has escaped from a light emitting layer in an electron transporting layer.

A concentration of a hole trapping material in an electron transporting layer in the second aspect of the present invention is preferably in a range of 0.1 to 30% by weight, further preferably in a range of 0.5 to 10% by weight, further preferably in a range of 1 to 5% by weight.

When a concentration of a hole trapping material is too high, since an electron transporting layer transports a hole, an amount of a hole which has escaped from a light emitting layer becomes large, and there is a possibility that a light emitting efficiency is reduced. On the other hand, when a concentration of a hole trapping material is too low, the effect of the present invention of improving light emitting life property is not sufficiently obtained in some cases.

A hole trapping material may be contained through an electron transporting layer, or may be contained only in a region of a part of an electron transporting layer.

The hole trapping material is not particularly limited as far as it satisfies the aforementioned first condition and second condition, but examples include compounds satisfying the aforementioned first condition and second condition among compounds such as a MTDATA derivative, a TPD (N,N′-bis(3-methylphenyl)-N,N′-diphenylbenzidine) derivative, a NPB derivative, a triphenylamine derivative, a phthalocyanine derivative, a rubrene derivative, and a ferrocene derivative.

According to the second aspect of the present invention, since a hole which has invaded into an electron transporting layer can be stably trapped by a hole trapping material, deterioration of an electron transporting material due to a hole can be prevented. For this reason, an organic EL device excellent in light emitting life property can be obtained. In addition, accompanying therewith, improvement in properties of an organic EL device, such as improvement in a light emitting efficiency and reduction in a driving voltage, can be expected.

### BRIEF DESCRIPTION OF THE DRAWINGS

FIG. 1 is a cross-sectional view showing an organic EL device prepared in Example in accordance with the first aspect of the present invention.

FIG. 2 is a view showing luminance-time property of an organic EL device of Example in accordance with the first aspect of the present invention.

FIG. 3 is a view of a cyclic voltammogram showing a cathode reduction process of rubrene.

FIG. 4 is a view of a cyclic voltammogram showing a cathode reduction process of tBuDPN.

FIG. 5 is a view of a cyclic voltammogram showing a cathode reduction process of DBzR.

FIG. 6 is a view of a cyclic voltammogram showing a cathode reduction process of perylene.

FIG. 7 is a view of a cyclic voltammogram showing a cathode reduction process of anthraquinone.

FIG. 8 is a view of a cyclic voltammogram showing a cathode reduction process of NPB.

FIG. 9 is a view of a cyclic voltammogram showing a cathode reduction process of CBP.

FIG. 10 is a cross-sectional view showing an organic EL device prepared in other Example in accordance with the first aspect of the present invention.

FIG. 11 is a view showing luminance-time property of an organic EL device of other Example in accordance with the first aspect of the present invention.

FIG. 12 is a view showing driving voltage-time property of an organic EL device of other Example in accordance with the first aspect of the present invention.

FIG. 13 is a cross-sectional view showing an organic EL device prepared in Example in accordance with the second aspect of the present invention.

FIG. 14 is a view showing luminance-time property of an organic EL device of Example in accordance with the second aspect of the present invention.

FIG. 15 is a view of a cyclic voltammogram showing an anode oxidation process of m-MTDATA.

FIG. 16 is a view of a cyclic voltammogram showing an anode oxidation process of NPB.

FIG. 17 is a view of a cyclic voltammogram showing an anode oxidation process of rubrene.

FIG. 18 is a view of a cyclic voltammogram showing an anode oxidation process of tBuDPN.

FIG. 19 is a view of a cyclic voltammogram showing an anode oxidation process of DBzR.

FIG. 20 is a view of a cyclic voltammogram showing an anode oxidation process of ferrocene.

FIG. 21 is a view of a cyclic voltammogram showing an anode oxidation process of BCP.

FIG. 22 is a view of a cyclic voltammogram showing an anode oxidation process of 9-phenylcarbazole.

### DESCRIPTION OF PREFERRED EXAMPLES

The present invention will be specifically explained in detail by way of Examples, but the present invention is not limited to the following Examples.

First, Examples in accordance with the first aspect of the present invention will be explained.

[Measurement of Cyclic Voltammetry]

Regarding respective compounds of rubrene, tBuDPN, DBzR, perylene, anthraquonone, NPB and CPB, cyclic voltammetry was measured.

In cyclic voltammetry, a work electrode, a counter electrode, and a reference electrode are inserted into an organic solvent in which a subject compound has been dissolved, a voltage is applied between a work electrode and a counter electrode, and a change in a potential and a current amount is measured. As a measurement instrument, a potentiostat (“HA-501” manufactured by Hokuto Denko Co., Ltd.) and a function generator (“HB-104” manufactured by Hokuto Denko Co., Ltd.) were used.

A sample was prepared by dissolving a compound at 10⁻³ mol/liter, dissolving tertiary-butyl ammonium perchloate as a supporting electrolyte at 10⁻¹ mol/liter, and using THF (tetrahydrofuran) as a solvent. Other conditions are as follows:
Sweep rate: 100 mV/sec
Sweep time: three times
Work electrode: platinum plate
Counter electrode: platinum wire
Reference electrode: Ag/AgNO₃ acetonitrile solution

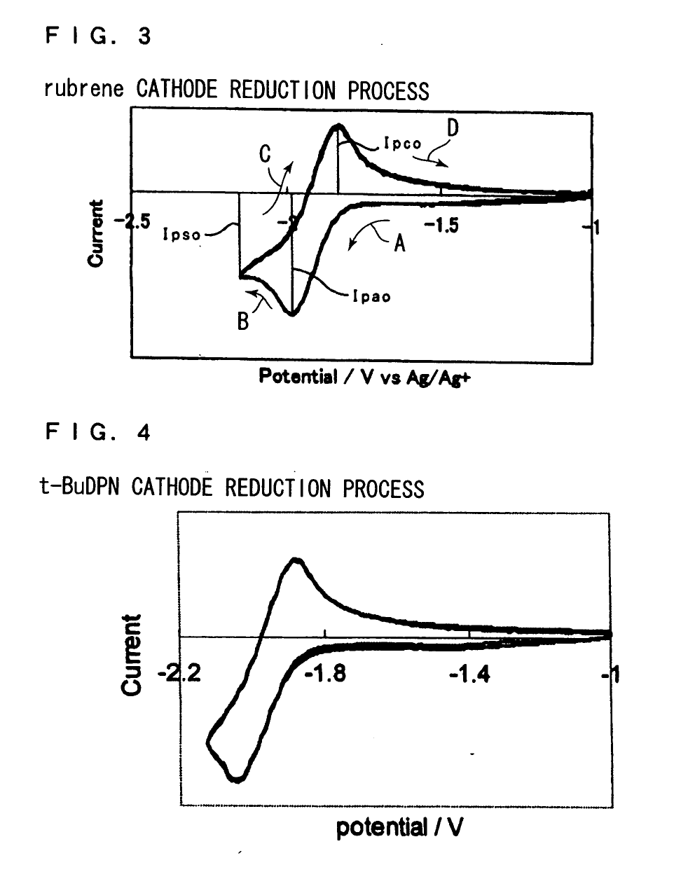

FIG. 3 is a cyclic voltammogram showing a cathode reduction process of rubrene. Rubrene has the following structure.

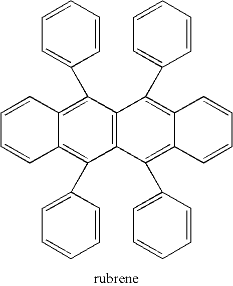

FIG. 4 is a cyclic voltammogram showing a cathode reduction process of tBuDPN. And, tBuDPN is 5,12-bis(4-tertiary-butylphenyl)naphthacene, and has the following structure.

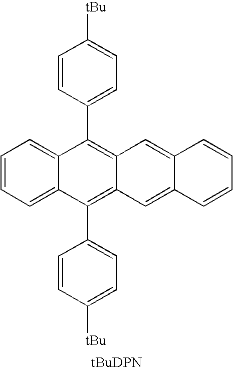

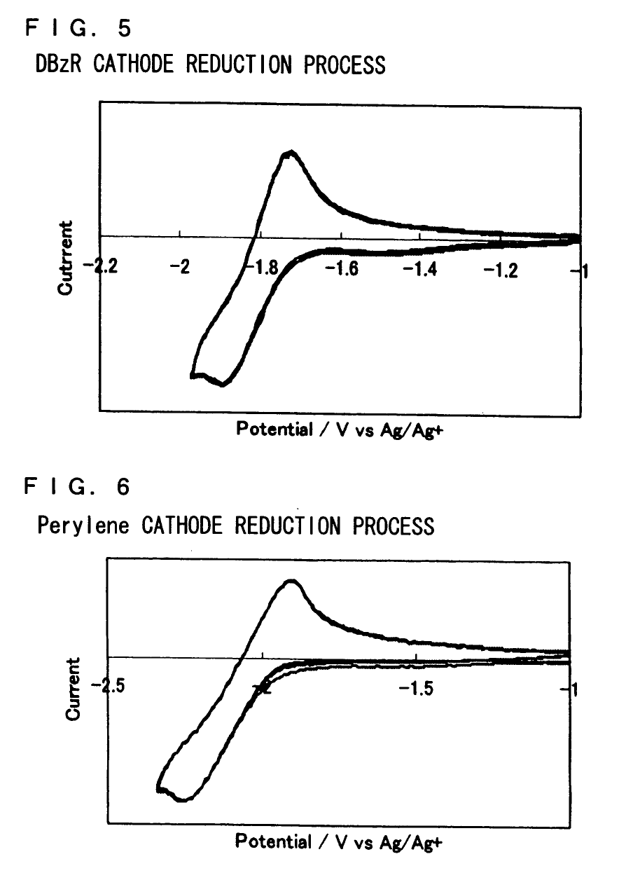

FIG. 5 is a cyclic voltammogram showing a cathode reduction process of DBzR. DBzR is 5,12-bis{4-(6-methylbenzothiazol-2-yl)phenyl}-6,11-diphenyl naphthacene, and has the following structure.

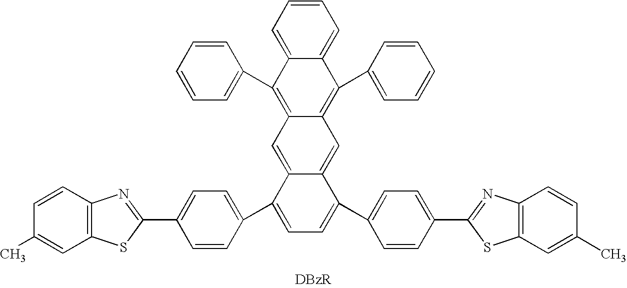

FIG. 6 is a cyclic voltammogram showing a cathode reduction process of perylene. Perylene has the following structure.

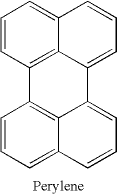

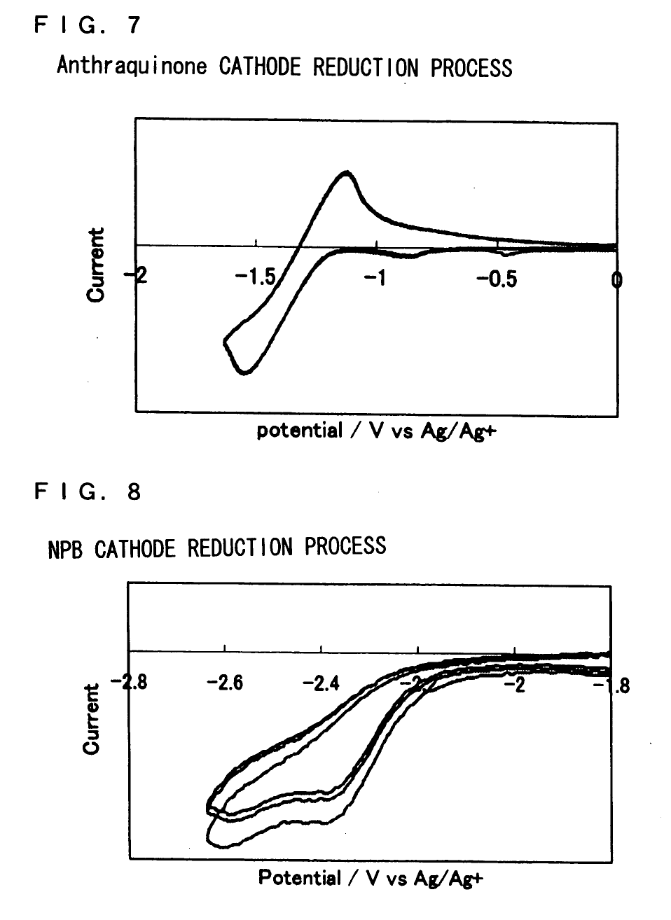

FIG. 7 is a cyclic voltammogram showing a cathode reduction process of anthraquinone. Anthraquinone has the following structure.

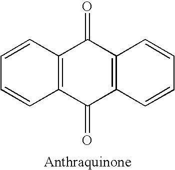

FIG. 8 is a cyclic voltammogram showing a cathode reduction process of NPB. NPB is N,N′-di(1-naphthyl)-N,N′-diphenylbenzidine, and has the following structure.

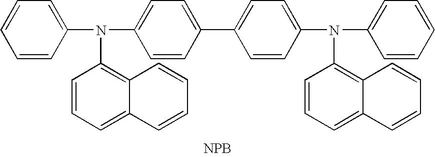

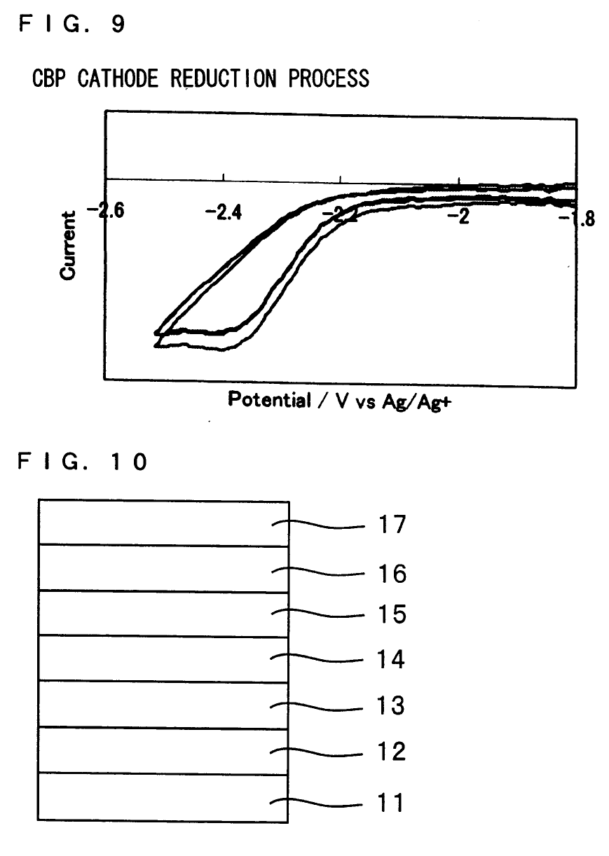

FIG. 9 is a cyclic voltammogram showing a cathode reduction process of CBP. CBP is 4,4′-bis(9-carbazolyl)-biphenyl, and has the following structure.

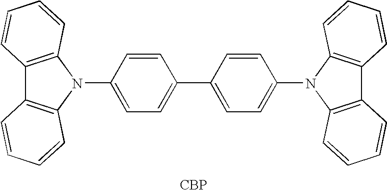

Regarding the aforementioned respective compounds, a reduction potential and I_{pc}/Iₚₐ were obtained as described above from their cyclic voltammograms, and they are shown in Table 1.

TABLE 1

| | | Reversibility of |
|---|---|---|
| | Reduction | cathode reduction |
| | Potential | process |
| Compound | V vs Ag/Ag⁺ | I_{pc}/Iₚₐ |
| Rubrene | −1.91 | 0.97 |
| tBuDPN | −1.96 | 0.97 |
| DBzR | −1.81 | 1.06 |
| Perylene | −2.08 | 1.08 |
| Anthraquinone | −1.59 | 0.99 |
| NPB | −2.30 | Irreversible |
| CBP | −2.27 | Irreversible |

As apparent from FIG. 8 and FIG. 9, it is seen that NPB and CBP are irreversible in a cathode reduction process. To the contrary, as apparent from FIG. 3 to FIG. 7, rubrene, tBuDPN, DBzR, perylene and anthraquinone show reversibility in a cathode reduction process. Iₚc/Iₚₐ is in a range of 0.97 to 1.08 as shown in Table 1.

[Preparation of Organic EL Device]

### EXAMPLE 1

An organic EL device having a structure shown in FIG. 1 was prepared. In an organic EL device shown in FIG. 1, an anode buffer layer 2 is disposed on a hole injection electrode 1, a hole transporting layer 3 is disposed thereon, and a light emitting layer 4 is disposed thereon. A hole arresting layer 5 and an electron transporting layer 6 are disposed on a light emitting layer 4, and an electron injection electrode 7 is disposed on a electrode transporting layer 6. This organic EL device is prepared on a glass substrate. A hole injection electrode 1 is formed of ITO (indium tin oxide), and an anode buffer layer 2 (thickness 0.1 nm) using CFx is formed thereon. A hole transporting layer 3 (thickness 50 nm) containing 5% by weight of tBuDPN as an electron trapping material is formed thereon using NPB as a hole transporting material. A light emitting layer 4 (thickness 25 nm) consisting of CBP containing 6.5% by weight of Ir(ppy)₃ is formed thereon. Ir(ppy)₃ is tris(2-phenylpyridine)iridium (III), and has the following structure.

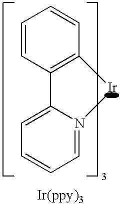

A hole arresting layer 5 (thickness 10 nm) is formed of BAlq. BAlq is bis(2-methyl-8-quinolinolato)-4-phenylphenolatoaluminum (III), and has the following structure.

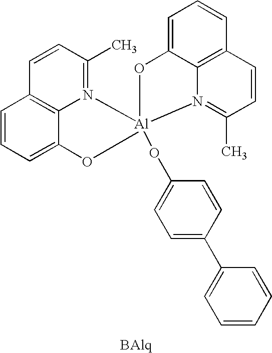

An electron transporting layer 6 (thickness 40 nm) is formed of Alq. Alq is tris-(8-quinolinato)aluminum (III), and has the following structure.

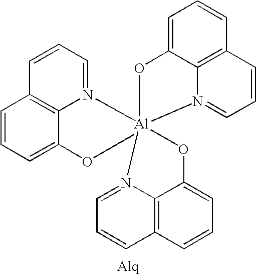

An electron injection electrode 7 is formed of a laminated structure of LiF (thickness 0.5 nm) and Al (thickness 200 nm)

An anode buffer layer CFx is formed by a plasma CVD method.

Other respective layers are formed by a vacuum deposition method.

### COMPARATIVE EXAMPLE 1

According to the same manner as that of the above Example 1 except that tBuDPN which is an electron trapping material was not contained in a hole transporting layer 3, an organic EL device was prepared.

### COMPARATIVE EXAMPLE 2

According to the same manner as that of the above Example 1 except that CPB was used as an electron trapping material to be contained in a hole transporting layer 3 in place of tBuDPN, an organic EL device was prepared.

[Assessment of Initial Property]

Regarding respective organic EL devices of Example 1, Comparative Example 1 and Comparative Example 2, a chromaticity and a light emitting efficiency were measured, and they are shown in Table 2.

TABLE 2

| | | | Current |
|---|---|---|---|
| | Driving Voltage | | Efficiency |
| | (V) | Chromaticity | (cd/A) |
| Example1 | 7.6 | (0.297, 0.634) | 37.2 |
| Comparative | 7.7 | (0.296, 0.628) | 30.3 |
| Example 1 | | | |
| Comparative | 7.4 | (0.295, 0.632) | 28.2 |
| Example 2 | | | |

As apparent from results shown in Table 2, an organic EL device of Example 1 shows a higher light emitting efficiency as compared with organic EL devices of Comparative Examples 1 and 2.

[Measurement of Luminance-Time Property]

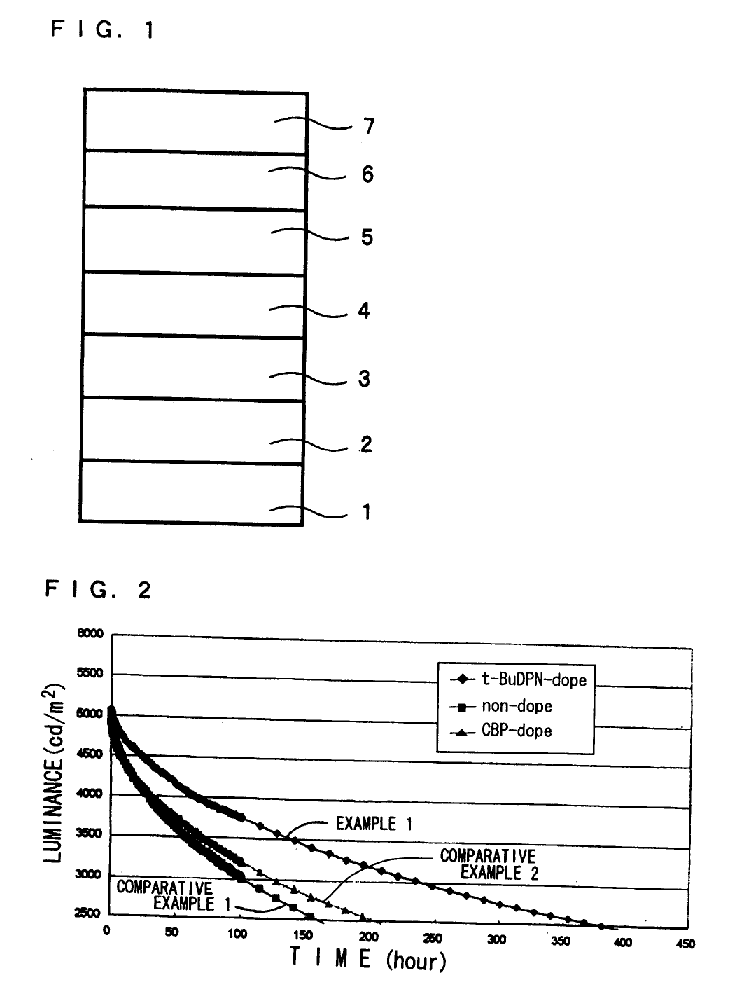

Regarding respective organic EL devices of Example 1, Comparative Example 1 and Comparative Example 2, luminance-time property was assessed. Assessment results are shown in FIG. 2.

As apparent from results shown in FIG. 2, it is seen that the organic EL device of Example 1 in accordance with the first aspect of the invention is excellent in light emitting life property as compared with organic EL devices of Comparative Example 1 and Comparative Example 2.

[Preparation of White Emitting Device]

### EXAMPLE 2

A white emitting organic EL device in which a light emitting layer was formed by laminating an orange emitting layer and a blue emitting layer, was prepared.

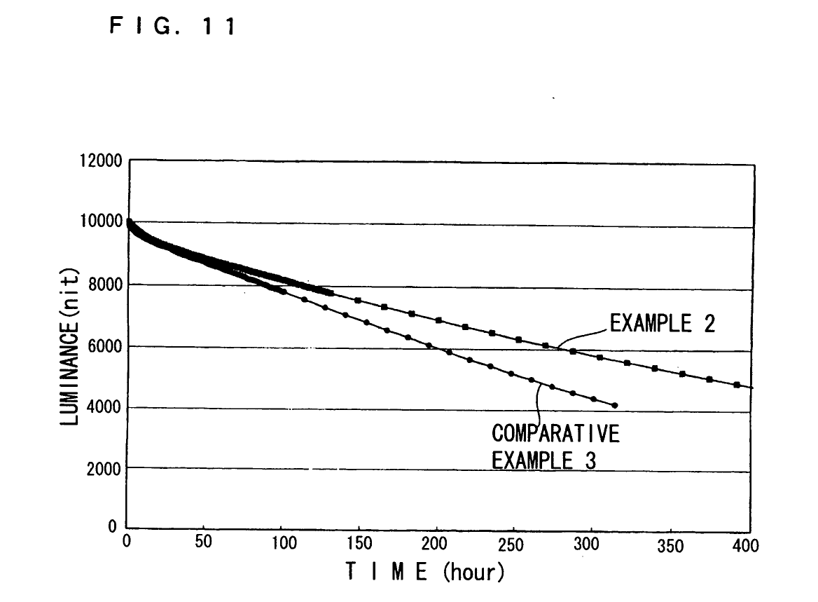

FIG. 10 is a cross-sectional view showing this white emitting organic EL device. As shown in FIG. 10, in this organic EL device, an anode buffer layer 12 is disposed on a hole injection electrode 11, and a hole transporting layer 13 is disposed thereon. An orange emitting layer 14 and a blue emitting layer 15 are disposed on a hole transporting layer 13 by lamination. An electron transporting layer 16 is disposed on these light emitting layers 14 and 15, and an electron injection electrode 17 is disposed on an electron transporting layer 16. This organic EL device is prepared on a glass substrate.

As in Example 1, a hole injection electrode 11 is formed of ITO, and an anode buffer layer 12 (thickness 1 nm) is formed of CFx.

A hole transporting layer 13 (thickness 110 nm) is formed of NPB containing 5% by weight of rubrene as an electron trapping material.

An orange emitting layer 14 (thickness 50 nm) uses 80% by weight of NPB and 20% by weight of tBuDPN as a host material, and contains 3% by weight of DBZR as a dopant material.

A blue emitting layer 15 (thickness 40 nm) uses 93% by weight of TBADN and 7% by weight of NPB as a host material, and contains 1% by weight of TBP as a dopant material. TBADN is 2-tertiary-butyl-9,10-di(2-naphthyl)anthracene, and has the following structure.

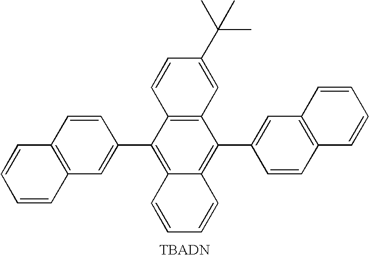

TBP is 2,5,8,11-tetra-tertiary-butylperylene, and has the following structure.

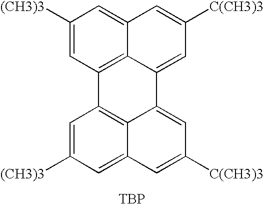

An electron transporting layer 16 (thickness 10 nm) is formed of Alq as in Example 1. An electron injection electrode 17 is formed of a laminated structure of LiF (thickness 1 nm) and Al (thickness 200 nm) as in Example 1. An anode buffer layer CFx is formed by a plasma CVD method, and other respective layers are formed by a vacuum deposition method.

In the case of a white emitting device formed by laminating an orange emitting layer and a blue emitting layer as in the present Example, it is preferable to use the same compound as a hole transporting material in a hole transporting layer as a host material, in an orange emitting layer adjacent to a hole transporting layer.

### COMPARATIVE EXAMPLE 3

According to the same manner as that of the aforementioned Example 2 except that rubrene which is an electron trapping material is not contained in a hole transporting layer 13, an organic EL device was prepared.

[Assessment of Initial Property]

Regarding respective organic EL devices of Example 2 and Comparative Example 3, a driving voltage, a chromaticity, a current efficiency and a power efficiency were measured at a current density of 20 mA/cm², and results of measurement are shown in Table 3.

TABLE 3

| | Driving | | Current | |
|---|---|---|---|---|
| | Voltage | | Efficiency | Power Efficiency |
| | (V) | Chromaticity | (cd/A) | (lm/W) |
| Example 2 | 7.5 | (0.30, 0.34) | 9.6 | 4.0 |
| Comparative | 7.5 | (0.29, 0.32) | 9.7 | 4.1 |
| Example 3 | | | | |

As apparent from results shown in Table 3, it is seen that the organic EL device of Example 2 and the organic EL device of Comparative Example 3 show the approximately same degree of a light emitting efficiency and an electric power efficiency.

[Measurement of Luminance-Time Property and Driving Voltage-Time Property]

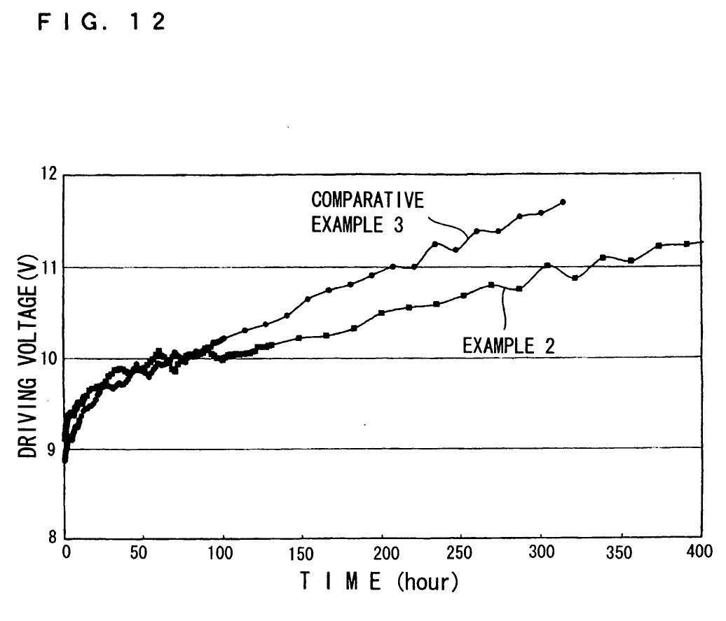

Regarding respective organic EL devices of Example 2 and Comparative Example 3, luminance-time property and driving voltage-time property were assessed. Assessment results of luminance-time property are shown in FIG. 11, and assessment results of driving voltage-time property are shown in FIG. 12, respectively. In a test for assessing driving voltage-time property shown in FIG. 12, a current was flown through each device so that an initial luminance became 10000nit, and a change in a luminance and a voltage when this constant current was continued to be flown was measured.

As apparent from results shown in FIG. 11, it is seen that the organic EL device of Example 2 in accordance with first aspect of the present invention is excellent in light emitting life property as compared with the organic EL device of Comparative Example 3.

In addition, as apparent from results shown in FIG. 12, it is seen that the organic EL device of Example 2 in accordance with the first aspect of the present invention maintains a driving voltage lower as compared with the organic EL device of Comparative Example 3.

Then, Examples in accordance with second aspect of the present invention will be explained.

[Measurement of Cyclic Voltammetry]

Regarding respective compounds of m-MTDATA, NPB, rubrene, tBuDPN, DBzR, ferrocene, BCP and 9-phenylcarbazole, cyclic voltammetry was measured.

In cyclic voltammetry, a work electrode, a counter electrode, and a reference electrode are inserted into an organic solvent in which a subject compound has been dissolved, a voltage is applied between a work electrode and a counter electrode, and a change in a potential and an electric amount is measured. As a measuring instrument, a potentiostat (“HA-501” manufactured by HOKUTO DENKO Co., Ltd.) and a function generator (“HB-104” manufactured by HOKUTO DENKO Co., Ltd.) were used.

A sample was prepared by dissolving a compound at 10⁻³ mol/liter, dissolving tertiary-butylammonium perchlorate as a supporting electrolyte at 10⁻¹ mol/liter, and using dichloromethane as a solvent. Other conditions are as follows:
Sweep rate: 100 mV/sec
Sweep time: three times
Work electrode: platinum plate
Counter electrode: platinum wire
Reference Electrode: Ag/AgNO₃ acetonitrile solution

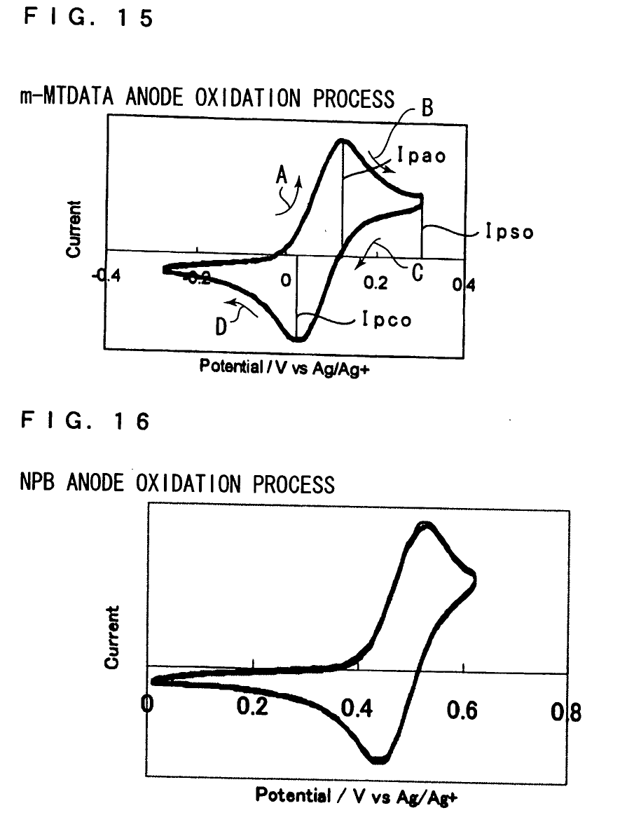

FIG. 15 is a cyclic voltammogram showing an anode oxidation process of m-MTDATA. And, m-MTDATA is {3-methylphenyl-(phenyl)-amino}4,4′,4″-tris(triphenylamine) and has the following structure.

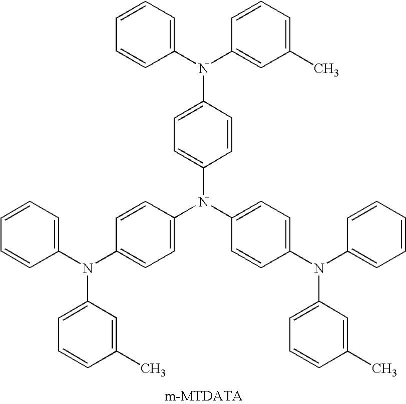

FIG. 16 is a cyclic voltammogram showing an anode oxidation process of NPB.

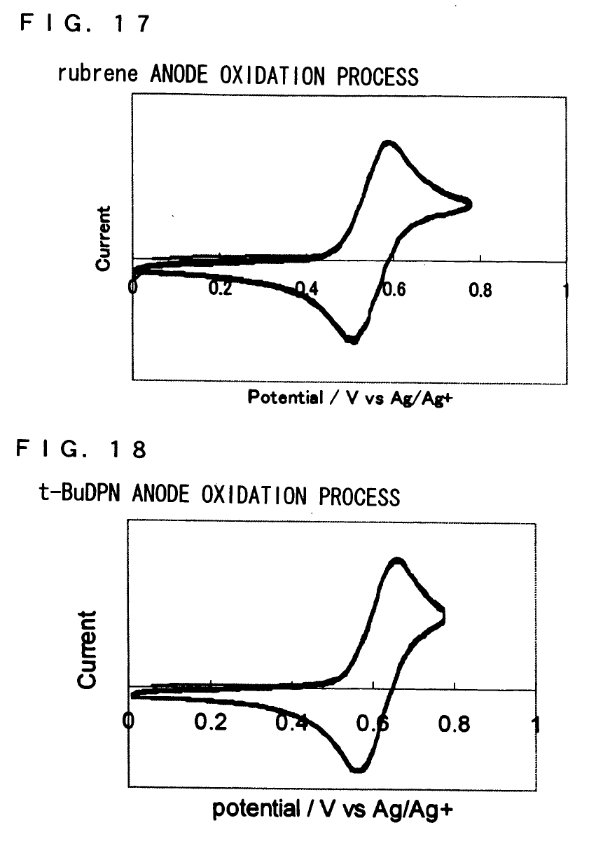

FIG. 17 is a cyclic voltammogram showing an anode oxidation process of rubrene.

FIG. 18 is a cyclic voltammogram showing an anode oxidation process of tBuDPN.

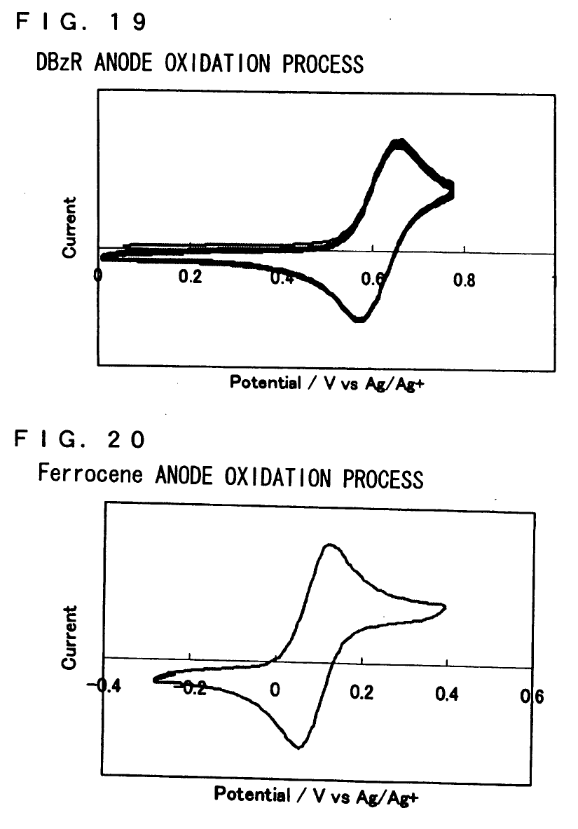

FIG. 19 is a cyclic voltammogram showing an anode oxidation process of DBZR.

FIG. 20 is a cyclic voltammogram showing an anode oxidation process of ferrocene.

Ferrocene has following structure.

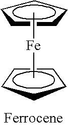

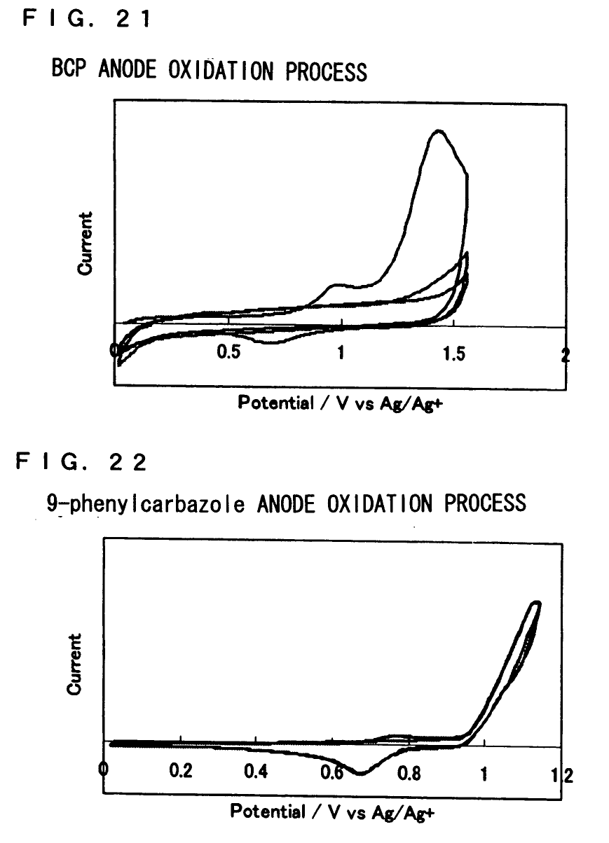

FIG. 21 is a cyclic voltammogram showing an anode oxidation process of BCP. BCP is 2,9-dimethyl-4,7-diphenyl-1,10-phenanthroline, and has the following structure.

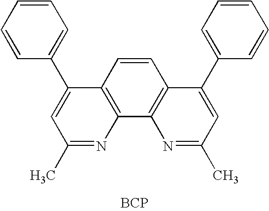

FIG. 22 is a cyclic voltammogram showing an anode oxidation process of 9-phenylcarbazole. 9-phenylcarbazole has the following structure.

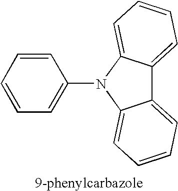

Regarding the aforementioned respective compounds, an oxidation potential and I_{pc}/Iₚₐ were obtained as described above from their cyclic voltammograms, and results are shown in Table 4.

TABLE 4

| | Oxidation | Reversibility of |
|---|---|---|
| | Potential | anode oxidation process |
| Compound | V vs Ag/Ag⁺ | I_{pc}/Iₚₐ |
| m-MTDATA | 0.08 | 1.00 |
| NPB | 0.48 | 1.00 |
| Rubrene | 0.55 | 1.00 |
| tBuDPN | 0.61 | 1.04 |
| DBzR | 0.61 | 1.02 |
| Ferrocene | 0.08 | 1.04 |
| BCP | 1.31 | Irreversible |
| 9-phenylcarbazole | 1.04 | Irreversible |

As apparent from FIG. 21 and FIG. 22, it is seen that BCP and 9-phenylcarbazole are irreversible in an anode oxidation process. To the contrary, m-MTDATA, NPB, rubren, tBuDPN, DBzR and ferrocene show reversibility in an anode oxidation process as apparent from FIG. 15 to FIG. 20. In addition, I_{pc}/Iₚₐ is in a range of 1.00 to 1.04 as shown in Table 4.

[Preparation of Organic EL Device]

### EXAMPLE 3

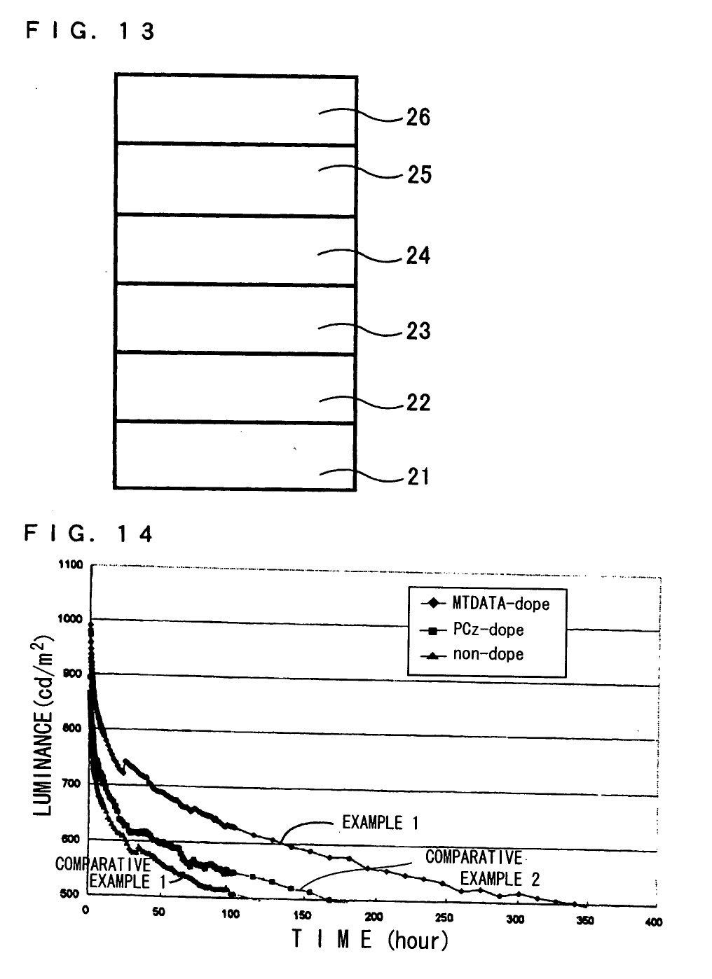

An organic EL device having a structure shown in FIG. 13 was prepared. In the organic EL device shown in FIG. 13, an anode buffer layer 22 is disposed on a hole injection electrode 21, a hole transporting layer 23 is disposed thereon, and a light emitting layer 24 is disposed thereon. An electron transporting layer 25 is disposed on a light emitting layer 24, and an electron injection electrode 26 is disposed on an electron transporting layer 25. This organic EL device is prepared on a glass substrate. A hole injection electrode 21 is formed of ITO (indium tin oxide), and an anode buffer layer 22 (thickness 0.1 nm) is formed thereon. A hole transporting layer 23 (thickness 50 nm) using NPB as a hole transporting material is formed thereon. A light emitting layer 24 (thickness 30 nm) consisting of Alq is formed thereon.

An electron transporting layer 25 (thickness 20 nm) uses BCP as an electron transporting material, and contains 5% by weight of m-MTDATA as a hole trapping material.

An electron injection electrode 26 (thickness 200 nm) is formed of Al.

An anode buffer layer CFx is formed by a plasma CVD method.

Other respective layers are formed by a vacuum deposition method.

### COMPARATIVE EXAMPLE 4

According to the same manner as that of the aforementioned Example 3 except that m-MTDATA which is a hole trapping material was not contained in an electron transporting layer 25, an organic EL device was prepared.

### COMPARATIVE EXAMPLE 5

According to the same manner as that of aforementioned Example 3 except that 9-phenylcarbazole was used as a hole trapping material to be contained in an electron transporting layer 25 in place of m-MTDATA, an organic EL device was prepared.

[Assessment of Initial Property]

Regarding respective organic EL devices of Example 3, Comparative Example 4 and Comparative Example 5, a driving voltage, a chromaticity and a current efficiency were measured at a current density of 20 mA/cm², and are shown in Table 5.

TABLE 5

| | | | Current |
|---|---|---|---|
| | Driving Voltage | | Efficiency |
| | (V) | Chromaticity | (cd/A) |
| Example 3 | 11.2 | (0.331, 0.564) | 3.4 |
| Comparative | 12.0 | (0.314, 0.560) | 2.8 |
| Example 4 | | | |
| Comparative | 11.4 | (0.316, 0.563) | 2.2 |
| Example 5 | | | |

As apparent from results shown in Table 5, the organic EL device of Example 3 shows a higher light emitting efficiency as compared with organic EL devices of Comparative Examples 4 and 5.

[Measurement of Luminance-Time Property]

Regarding respective organic EL devices of Example 3, Comparative Example 4 and Comparative Example 5, luminance-time property was assessed. Assessment results are shown in FIG. 14.

As apparent from results shown in FIG. 14, it is seen that the organic EL device of Example 3 in accordance with second aspect of the present invention is excellent in light emitting life property as compared with organic EL devices of Comparative Example 4 and Comparative Example 5.

What is claimed is:

1. An organic electroluminescence device comprising; a hole injection electrode; an electron injection electrode; a light emitting layer disposed between the hole injection electrode and the electron injection electrode; and a hole transporting layer disposed between the hole injection electrode and the light emitting layer;
wherein the hole transporting layer contains an electron trapping material exhibiting a reversible cathode reduction process in cyclic voltammetry measurement and having a reduction potential smaller than that of a hole transporting material contained in the hole transporting layer.

2. The organic electroluminescence device according to claim 1, wherein a concentration of the electron trapping material in the hole transporting layer is in a range of 0.1 to 30% by weight.

3. The organic electroluminescence device according to claim 1, wherein the hole transporting material is an arylamine derivative.

4. The organic electroluminescence device according to claim 1, wherein the electric trapping material is a rubrene derivative.

5. The organic electroluminescence device according to claim 1, wherein the electric trapping material is a perylene derivative.

6. The organic electroluminescence device according to claim 1, wherein the electron trapping material is an anthraquinone derivative.

7. The organic electroluminescence device according to claim 1, wherein the light emitting layer is composed of a host material and a dopant material.

8. The organic electroluminescence device according to claim 1, wherein the light emitting layer is constituted only by one layer.

9. The organic electroluminescence device according to claim 1, wherein the light emitting layer is constituted by two layers or three layers having different emitting colors.

10. The organic electroluminescence device according to claim 7, wherein the host material of the light emitting layer is an anthracene derivative, an aluminum complex, a rubrene derivative or an arylamine derivative.

11. The organic electroluminescence device according to claim 7, wherein the host material of a light emitting layer adjacent to the hole transporting layer is the same compound as a hole transporting material of the hole transporting layer.

12. The organic electroluminescence device according to claim 1, which is a white emitting device in which a blue emitting layer and an orange emitting layer are disposed by lamination, as the light emitting layer.

13. The organic electroluminescence device according to claim 7, wherein a phosphorescent emitting material is contained as the dopant material.

14. An organic electroluminescence device comprising; a hole injection electrode; an electron injection electrode; a light emitting layer disposed between the hole injection electrode and the electron injection electrode; and an electron transporting layer disposed between the electron injection electrode and the light emitting layer;
wherein the electron transporting layer contains a hole trapping material exhibiting a reversible anode reduction process in cyclic voltammetry measurement and having an oxidation potential smaller than that of an electron transporting material contained in the electron transporting layer.

15. The organic electroluminescence device according to claim 1, wherein a concentration of the hole trapping material in the electron transporting layer in a range of 0.1 to 30% by weight.

16. The organic electroluminescence device according to claim 14, wherein the light emitting layer is composed of a host material and a dopant material.

17. The organic electroluminescence device according to claim 14, wherein the light emitting layer is constituted only by one layer.

18. The organic electroluminescence device according to claim 14, wherein the light emitting layer is constituted by two layers or three layers having different emitting colors.

19. The organic electroluminescence device according to claim 16, wherein the host material of the light emitting layer is an anthracene derivative, an aluminum complex, a rubrene derivative, or an arylamine derivative.

20. The organic electroluminescence device according to claim 16, wherein the host material of a light emitting layer adjacent to the hole transporting layer is the same compound as a hole transporting material of the hole transporting layer.

21. The organic electroluminescence device according to claim 14, which is a white emitting device in which a blue emitting layer and an orange emitting layer are disposed by lamination, as the light emitting layer.

22. The organic electroluminescence device according to claim 16, wherein the phosphorescent emitting material is contained as the dopant material.
